(19) United States
(12) Patent Application Publication
(10) Pub. No.: US 2011/0207874 A1
(43) Pub. Date: Aug. 25, 2011

(54) CONJUGATED DIENE POLYMER, CONJUGATED DIENE POLYMER COMPOSITION, AND METHOD FOR PRODUCING CONJUGATED DIENE POLYMER

(75) Inventors: Mana Ito, Tokyo (JP); Katsunari Inagaki, Chiba (JP)

(73) Assignee: SUMITOMO CHEMICAL COMPANY, LIMITED, Tokyo (JP)

(21) Appl. No.: 13/033,322

(22) Filed: Feb. 23, 2011

(30) Foreign Application Priority Data
Feb. 25, 2010 (JP) 2010-039997
May 6, 2010 (JP) 2010-106181

(51) Int. Cl. C08F 8/30; C08F 236/10; C08L 9/00; C08F 4/46

(52) U.S. Cl. 524/502; 525/296; 525/271

(57) ABSTRACT

A conjugated diene polymer is provided that includes a conjugated diene-based monomer unit and a monomer unit based on a compound represented by Formula (1) below, the monomer unit based on a compound represented by Formula (1) below being between a conjugated diene-based monomer unit-containing partial chain and a conjugated diene-based monomer unit-containing partial chain (said partial chain not comprising a monomer unit based on a compound represented by Formula (1) below), and the polymer having at least one terminus modified by a compound represented by Formula (2) below,

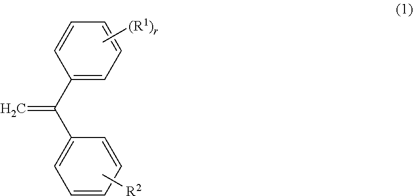

wherein r is 0 or 1, R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom,

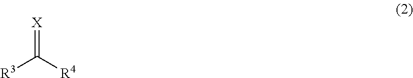

wherein X denotes an oxygen atom or a sulfur atom, R³ denotes a nitrogen atom- and/or oxygen atom-containing group, a hydrocarbyl group, or a hydrogen atom, R⁴ denotes a nitrogen atom- and/or oxygen atom-containing group, and R³ and R⁴ may be bonded to each other. There is also provided a method for producing a conjugated diene polymer.

### FIELD OF THE INVENTION

The present invention relates to a conjugated diene polymer, a conjugated diene polymer composition, and a method for producing a conjugated diene polymer.

### BACKGROUND OF THE INVENTION

In recent years, with the growing concern over environmental problems the demand for good fuel economy for automobiles has been becoming stronger, and there is also a demand for excellent fuel economy for polymer compositions used for automobile tires. As a polymer composition for automobile tires, a polymer composition comprising a conjugated diene polymer such as polybutadiene or a butadiene-styrene copolymer and a reinforcing agent such as carbon black or silica, etc. is used.

For example, a polymer composition employing a reinforcing agent and a conjugated diene polymer formed by modifying with a dialkylamino group-containing acrylamide one terminus of a polymer formed by copolymerizing butadiene and styrene using an alkyllithium as a polymerization initiator (see e.g. JP•A•1-217047 (JP-A denotes a Japanese unexamined patent application publication)), a polymer composition employing a reinforcing agent and a conjugated diene polymer formed by modifying with a dialkylamino group-containing 1,1-diphenylethylene one terminus of a polymer formed by copolymerizing butadiene and styrene using an alkyllithium as a polymerization initiator (see e.g. JP•A•2003-160603), etc. have been proposed as polymer compositions having good fuel economy.

### SUMMARY OF THE INVENTION

However, the above-mentioned conventional polymer compositions employing a conjugated diene polymer are not always satisfactory in terms of fuel economy.

Under such circumstances, an object of the present invention is to provide a conjugated diene polymer that can give a conjugated diene polymer composition having excellent fuel economy, a conjugated diene polymer composition containing the conjugated diene polymer and a reinforcing agent such as silica, and a method for producing the conjugated diene polymer.

A first aspect of the present invention relates to a conjugated diene polymer comprising a conjugated diene-based monomer unit and a monomer unit based on a compound represented by Formula (1) below, the monomer unit based on a compound represented by Formula (1) below being between a conjugated diene-based monomer unit-containing partial chain and a conjugated diene-based monomer unit-containing partial chain (said partial chain not comprising a monomer unit based on a compound represented by Formula (1) below), and the polymer having at least one terminus modified by a compound represented by Formula (2) below.

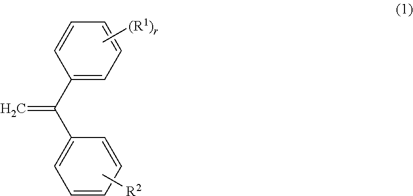

(In the formula, r is 0 or 1, R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom.)

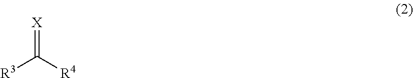

(In the formula, X denotes an oxygen atom or a sulfur atom, R³ denotes a nitrogen atom- and/or oxygen atom-containing group, a hydrocarbyl group, or a hydrogen atom, R⁴ denotes a nitrogen atom- and/or oxygen atom-containing group, and R³ and R⁴ may be bonded to each other.)

A second aspect of the present invention relates to a conjugated diene polymer composition comprising the conjugated diene polymer and a reinforcing agent.

A third aspect of the present invention relates to a method for producing a conjugated diene polymer, comprising the steps of

(A) polymerizing monomer components comprising a conjugated diene and a compound represented by Formula (1) below in a hydrocarbon solvent using an alkali metal catalyst, thus giving a polymer containing a monomer unit based on a compound represented by Formula (1) below between a conjugated diene-based monomer unit-containing partial chain and a conjugated diene-based monomer unit-containing partial chain (said partial chain not comprising a monomer unit based on a compound represented by Formula (1) below), the polymer having an alkali metal catalyst-derived alkali metal in at least one terminus of a polymer chain, and
(B) reacting the polymer obtained in step A and a compound represented by Formula (2) below.

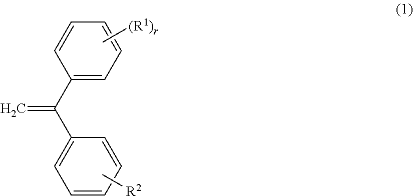

(In the formula, r is 0 or 1, R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom.)

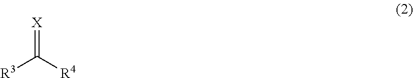

(In the formula, X denotes an oxygen atom or a sulfur atom, R³ denotes a nitrogen atom- and/or oxygen atom-containing group, a hydrocarbyl group, or a hydrogen atom, R⁴ denotes a nitrogen atom- and/or oxygen atom-containing group, and R³ and R⁴ may be bonded to each other.)

### DETAILED DESCRIPTION OF THE INVENTION

The conjugated diene polymer of the present invention is a conjugated diene polymer containing a conjugated diene-based monomer unit and a monomer unit based on a compound represented by Formula (1) above, and is a conjugated diene polymer containing a monomer unit based on a compound represented by Formula (1) above between a conjugated diene-based monomer unit-containing partial chain (not containing a monomer unit based on a compound represented by Formula (1)) and a conjugated diene-based monomer unit-containing partial chain (not containing a monomer unit based on a compound represented by Formula (1)), at least one terminus of the polymer being modified by a compound represented by Formula (2) above.

Examples of the conjugated diene include 1,3-butadiene, isoprene, 1,3-pentadiene, 2,3-dimethyl-1,3-butadiene, and 1,3-hexadiene, and one or more types thereof may be used. The conjugated diene is preferably 1,3-butadiene or isoprene.

In Formula (1), r is 0 or 1.

In Formula (1), R¹ and R² are substituents on the benzene rings, and the substitution position may be any of the 2-position, 3-position, 4-position, 5-position, and 6-position; it is preferably the 3-position, 4-position, or 5-position, and more preferably the 4-position.

With regard to the substitution position of R¹, the position of the benzene ring to which the following group is bonded is defined as the 1-position. The position of bonding to the benzene ring on which R¹ is substituted is denoted by * in the formula below.

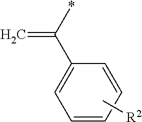

With regard to the substitution position of R², the position of the benzene ring to which the following group is bonded is defined as the 1-position. The position of bonding to the benzene ring on which R² is substituted is denoted by * in the formula below.

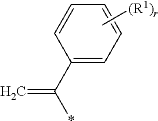

In Formula (1), R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom. R² is preferably an aliphatic or cyclic group having 0 to 6 carbon atoms in which a nitrogen atom, oxygen atom, or sulfur atom is directly bonded to the phenyl group.

In the present specification, a hydrocarbyl group denotes a hydrocarbon residue, and a hydrocarbyloxy group denotes a group in which the hydrogen atom of a hydroxyl group is replaced with a hydrocarbyl group.

With regard to the group, denoted by R¹ and R², containing at least one atom selected from the atomic group consisting of a nitrogen atom, an oxygen atom, and a sulfur atom, examples of the nitrogen atom-containing group include an amino group, a dimethylamino group, a diethylamino group, an isocyano group, a 1-aziridinyl group, a 1-pyrrolidinyl group, a 1-piperidinyl group, a 1-hexamethyleneimino group, a 1-imidazolyl group, a 4,5-dihydro-1-imidazolyl group, a 1-imidazolidinyl group, a 1-piperazinyl group, and a morpholino group. Further examples include a cyano group, a 2-pyrrolidyl group, a 2-piperidinyl group, a 2-pyridyl group, a 3-pyridyl group, a 4-pyridyl group, and a 2-pyrazinyl group.

With regard to the group, denoted by R¹ and R², containing at least one atom selected from the atomic group consisting of a nitrogen atom, an oxygen atom, and a sulfur atom, examples of the oxygen atom-containing group include a hydrocarbyloxy group such as an alkoxy group, an aryloxy group, or an aralkyloxy group; a substituted hydrocarbyl group containing a hydrocarbyloxy group as a substituent such as an alkoxyalkyl group or an alkoxyaryl group; a heterocyclic group containing an oxygen atom as a ring-constituting heteroatom; a trihydrocarbylsilyloxy group such as a trialkylsilyloxy group; and a trihydrocarbyloxysilyl group such as a trialkoxysilyl group.

Examples of the alkoxy group include a methoxy group, an ethoxy group, an n-propoxy group, an isopropoxy group, an n-butoxy group, a sec-butoxy group, and a t-butoxy group. Examples of the aryloxy group include a phenoxy group. Examples of the aralkyloxy group include a benzyloxy group. Examples of the alkoxyalkyl group include a methoxymethyl group, a methoxyethyl group, an ethoxymethyl group, and an ethoxyethyl group. Examples of the alkoxyaryl group include a methoxyphenyl group and an ethoxyphenyl group. Examples of the heterocyclic group containing an oxygen atom as a ring-constituting heteroatom include an oxiranyl group, a tetrahydrofuranyl group, and a dioxolanyl group. Examples of the trialkylsilyloxy group include a trimethylsilyloxy group, a triethylsilyloxy group, a triisopropylsilyloxy group, and a t-butyldimethylsilyloxy group. Examples of the trialkoxysilyl group include a trimethoxysilyl group, a triethoxysilyl group, and a tri-n-propoxysilyl group.

With regard to the group, denoted by R¹ and R², containing at least one atom selected from the atomic group consisting of a nitrogen atom, an oxygen atom, and a sulfur atom, examples of the sulfur atom-containing group include a mercapto group.

The group containing at least one atom selected from the atomic group consisting of a nitrogen atom, an oxygen atom, and a sulfur atom is preferably a nitrogen atom-containing group, and more preferably a group represented by Formula (3) below.

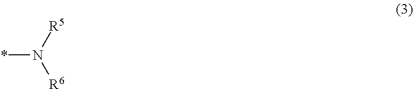

(In the formula, R⁵ and R⁶ independently denote a hydrocarbyl group or a trihydrocarbylsilyl group, or R⁵ and R⁶ are bonded to each other and denote a hydrocarbylene group that may contain a nitrogen atom and/or an oxygen atom as a heteroatom, and * denotes a bonding position.)

The hydrocarbyl group denoted by R⁵ and R⁶ is preferably a hydrocarbyl group having 1 to 10 carbon atoms. Examples of the hydrocarbyl group include an alkyl group and an aryl group. Examples of the alkyl group include a methyl group, an ethyl group, an n-propyl group, an isopropyl group, an n-butyl group, a sec-butyl group, and a tert-butyl group. Examples of the aryl group include a phenyl group. The hydrocarbyl group is preferably an alkyl group, and more preferably an alkyl group having 1 to 4 carbon atoms.

As the trihydrocarbylsilyl group denoted by R⁵ and R⁶, a trialkylsilyl group, etc. can be cited. Examples of the trialkylsilyl group include a trimethylsilyl group, a triethylsilyl group, a triisopropylsilyl group, and a tert-butyldimethylsilyl group. It is preferably a trialkylsilyl group having 3 to 9 carbon atoms, and more preferably a trialkylsilyl group in which the alkyl group bonded to the silicon atom is an alkyl group having 1 to 3 carbon atoms.

Examples of a divalent group (—R⁵-R⁶—) in which R⁵ and R⁶ are bonded include an alkylene group such as an ethylene group, a trimethylene group, a tetramethylene group, a pentamethylene group, or a hexamethylene group; a nitrogen atom-containing hydrocarbylene group such as a group represented by —CH₂CH₂—NH—CH₂—, a group represented by —CH₂CH₂—N═CH—, a group represented by —CH═CH—N═CH—, or a group represented by —CH₂CH₂—NH—CH₂CH₂—; and an oxygen atom-containing hydrocarbylene group such as a group represented by —CH₂CH₂—O—CH₂CH₂—.

In the present specification, the hydrocarbylene group means a divalent hydrocarbon residue; the hydrocarbylene group containing an X atom as a heteroatom means a group having a structure in which a hydrogen atom and/or a carbon atom of a hydrocarbylene group is replaced by an X atom. Examples of a hydrocarbylene group containing a nitrogen atom as a heteroatom include a group having a structure in which CH of a hydrocarbylene group is replaced by N. Examples of a hydrocarbylene group containing an oxygen atom as a heteroatom include a group having a structure in which CH₂ is replaced by O and a group having a structure in which two hydrogen atoms are replaced by O. Examples of a hydrocarbylene group containing a silicon atom as a heteroatom include a group having a structure in which C is replaced by Si.

As the group represented by Formula (3) above, an acyclic amino group and a cyclic amino group can be cited. Examples of the acyclic amino group include a dialkylamino group such as a dimethylamino group, a diethylamino group, a di(n-propyl)amino group, a di(isopropyl)amino group, a di(n-butyl)amino group, a di(sec-butyl)amino group, a di(tert-butyl)amino group, or an ethylmethylamino group; a diarylamino group such as a diphenylamino group; and a bis(trialkylsilyl)amino group such as a bis(trimethylsilyl)amino group, a bis(triethylsilyl)amino group, a bis(t-butyldimethylsilyl)amino group, or a bis(triisopropylsilyl)amino group.

Examples of the cyclic amino group include a 1-aziridinyl group, a 1-pyrrolidinyl group, a 1-piperidinyl group, a 1-hexamethyleneimino group, a 1-heptamethyleneimino group, a 1-octamethyleneimino group, a 1-decamethyleneimino group, a 1-dodecamethyleneimino group, a 1-imidazolyl group, a 4,5-dihydro-1-imidazolyl group, a 1-imidazolidinyl group, a 1-piperazinyl group, and a morpholino group.

The group represented by Formula (3) is preferably an acyclic amino group, and more preferably a dialkylamino group.

As the hydrocarbyl group denoted by R¹, an alkyl group, an aryl group, etc. can be cited. Examples of the alkyl group include a methyl group, an ethyl group, an n-propyl group, an isopropyl group, an n-butyl group, a sec-butyl group, and a tert-butyl group. Examples of the aryl group include a phenyl group. The hydrocarbyl group is preferably a hydrocarbyl group having 1 to 10 carbon atoms.

The compound represented by Formula (1) is preferably a compound in which r=0 or a compound in which r=1 and R¹ is a hydrocarbyl group, more preferably a compound in which r=0, and yet more preferably a compound in which r=0 and R² is a group represented by Formula (3) above.

Examples of the compound represented by Formula (1) include
1-(4-N,N-dimethylaminophenyl)-1-phenylethylene,
1-(4-N,N-diethylaminophenyl)-1-phenylethylene,
1-(4-N,N-dipropylaminophenyl)-1-phenylethylene,
1-(4-N,N-diisopropylaminophenyl)-1-phenylethylene,
1-(4-N,N-dibutylaminophenyl)-1-phenylethylene,
1-(4-N,N-diisobutylaminophenyl)-1-phenylethylene,
1-(4-N,N-di(tert-butyl)aminophenyl)-1-phenylethylene,
1-(4-N,N-diphenylaminophenyl)-1-phenylethylene,
1-(4-(1-aziridinyl)phenyl)-1-phenylethylene,
1-(4-(1-pyrrolidinyl)phenyl)-1-phenylethylene,
1-(4-(1-piperidinyl)phenyl)-1-phenylethylene,
1-(4-hexamethyleneiminophenyl)-1-phenylethylene,
1-(4-morpholinophenyl)-1-phenylethylene,
1-(4-(N,N-bis(trimethylsilyl)amino)phenyl)-1-phenylethylene,
1-(4-(N,N-bis(tert-butyldimethylsilyl)amino)phenyl)-1-phenylethylene, and
1-(4-(N,N-bis(triisopropylsilyl)amino)phenyl)-1-phenylethylene.

1-(4-N,N-Dimethylaminophenyl)-1-phenylethylene is preferable.

In Formula (2), X denotes an oxygen atom or a sulfur atom. An oxygen atom is preferable.

In Formula (2), R³ denotes a nitrogen atom- and/or oxygen atom-containing group, a hydrocarbyl group, or a hydrogen atom, R⁴ denotes a nitrogen atom- and/or oxygen atom-containing group, and R³ and R⁴ may be bonded to each other.

As the hydrocarbyl group denoted by R³, an alkyl group, an alkenyl group, an aryl group, etc. can be cited. Examples of the alkyl group include a methyl group, an ethyl group, an n-propyl group, an isopropyl group, an n-butyl group, a sec-butyl group, and a tert-butyl group. Examples of the alkenyl group include a vinyl group, an allyl group, a 1-propenyl group, and a 1-methylethenyl group. Examples of the aryl group include a phenyl group. The hydrocarbyl group is preferably a hydrocarbyl group having 1 to 10 carbon atoms, more preferably an alkyl group having 1 to 10 carbon atoms or an alkenyl group having 2 to 10 carbon atoms, and yet more preferably an alkenyl group having 2 or 3 carbon atoms.

With regard to the nitrogen atom- and/or oxygen atom-containing group denoted by R³ and R⁴, as the nitrogen atom-containing group, an amino group, a substituted amino group, a substituted hydrocarbyl group containing an amino group and/or a substituted amino group as a substituent, a heterocyclic group containing a nitrogen atom as a ring-constituting heteroatom, etc. can be cited. Examples of the substituted amino group include a dihydrocarbylamino group such as a dimethylamino group or a diethylamino group; and a cyclic amino group such as a 1-aziridinyl group, a 1-pyrrolidinyl group, a 1-piperidinyl group, a hexamethyleneimino group, a 1-imidazolyl group, a 4,5-dihydro-1-imidazolyl group, a 1-imidazolidinyl group, a 1-piperazinyl group, or a morpholino group. Examples of the substituted hydrocarbyl group containing a substituted amino group as a substituent include a dihydrocarbylaminoalkyl group such as a dimethylaminoethyl group or a diethylaminoethyl group; and a dihydrocarbylaminoaryl group such as a dimethylaminophenyl group or a diethylaminophenyl group. Examples of the heterocyclic group containing a nitrogen atom as a ring-constituting heteroatom include a 2-pyrrolidyl group, a 2-piperidinyl group, a 2-pyridyl group, a 3-pyridyl group, a 4-pyridyl group, and a 2-pyrazinyl group.

With regard to the nitrogen atom- and/or oxygen atom-containing group denoted by R³ and R⁴, as the oxygen atom-containing group, a hydrocarbyloxy group, a substituted hydrocarbyloxy group, a substituted hydrocarbyl group containing a hydrocarbyloxy group as a substituent, a heterocyclic group containing an oxygen atom as a ring-constituting heteroatom, etc. can be cited. Examples of the hydrocarbyloxy group include an alkoxy group, an aryloxy group, and an aralkyloxy group. Examples of the alkoxy group include a methoxy group, an ethoxy group, an n-propoxy group, an isopropoxy group, an n-butoxy group, a sec-butoxy group, and a tert-butoxy group. Examples of the aryloxy group include a phenoxy group. Examples of the aralkyloxy group include a benzyloxy group.

Examples of the substituted hydrocarbyloxy group include an alkoxyalkoxy group such as a methoxymethoxy group, a methoxyethoxy group, an ethoxymethoxy group, and an ethoxyethoxy group. Examples of the substituted hydrocarbyl group containing a hydrocarbyloxy group as a substituent include an alkoxyalkyl group such as a methoxymethyl group, a methoxyethyl group, an ethoxymethyl group, or an ethoxyethyl group; and an alkoxyaryl group such as a methoxyphenyl group or an ethoxyphenyl group. Examples of the heterocyclic group containing an oxygen atom as a ring-constituting heteroatom include a monooxacycloalkyl group such as an oxiranyl group or a tetrahydrofuranyl group; and a dioxacycloalkyl group such as a dioxolanyl group.

In the present specification, the monooxacycloalkyl group means a group in which one CH₂ of a cycloalkyl group is replaced by an oxygen atom. The dioxacycloalkyl group means a group in which two CH₂s of a cycloalkyl group are replaced by oxygen atoms.

R³ and R⁴ may be bonded to each other, and as a divalent group (—R³-R⁴—) in which R³ and R⁴ are bonded a group represented by —NR′—(CH₂)ₚ— in the formula, p denotes an integer of 1 to 10 and R′ denotes a hydrogen atom or a hydrocarbyl group], a group represented by —NR″—(CH₂)_{q}—NR′″-[in the formula, q denotes an integer of 1 to 10 and R″ and R′″ independently denote a hydrogen atom or a hydrocarbyl group], etc. can be cited.

With regard to the compound represented by Formula (2), examples of the compound in which R³ is a hydrogen atom include a formamide, a thioformamide, a formate ester, a thioformate ester, a nitrogen atom- and/or oxygen atom-containing group-containing benzaldehyde, and a nitrogen atom- and/or oxygen atom-containing group-containing thiobenzaldehyde.

Examples of the compound in which R³ is a hydrocarbyl group include an acetamide, a thioacetamide, an acetate ester, a thioacetate ester, an acrylate ester, a methacrylate ester, an acrylamide, a methacrylamide, a nitrogen atom- and/or oxygen atom-containing group-containing acetophenone, a nitrogen atom- and/or oxygen atom-containing group-containing thioacetophenone, a nitrogen atom- and/or oxygen atom-containing group-containing benzophenone, and a nitrogen atom- and/or oxygen atom-containing group-containing thiobenzophenone. Examples further include a cyclic compound such as a lactam.

Examples of compounds in which R³ and R⁴ are amino groups include a urea and a thiourea. Examples further include a cyclic compound such as an imidazolidinone.

Examples of compounds in which R³ and R⁴ are alkoxy groups include a carbonate ester and a thiocarbonate ester. Examples further include a cyclic compound such as a dioxanone.

Examples of compounds in which R³ is an amino group and R⁴ is an alkoxy group include a urethane and a thiourethane.

The compound represented by Formula (2) is preferably a compound in which X is an oxygen atom, R³ is a hydrocarbyl group or a nitrogen atom-containing group, and R⁴ is a nitrogen atom-containing group, is more preferably a compound in which X is an oxygen atom, R³ is a hydrocarbyl group or a group represented by Formula (4) below, and R⁴ is a group represented by Formula (4) below, and is yet more preferably a compound in which X is an oxygen atom, R³ is a hydrocarbyl group, and R⁴ is a group represented by Formula (4) below. R³ and R⁴ may be a group in which these groups are bonded to each other.

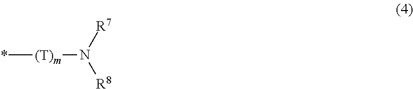

(In the formula, m is 0 or 1, T denotes a hydrocarbylene group having 1 to 10 carbon atoms, a group represented by Formula (5) below, or a group represented by Formula (6) below, R⁷ and R⁸ independently denote a hydrogen atom, a hydrocarbyl group having 1 to 10 carbon atoms, or a trihydrocarbylsilyl group, or R⁷ and R⁸ are bonded to each other and denote a hydrocarbylene group that may contain a nitrogen atom and/or an oxygen atom as a heteroatom, R⁷ and R⁸ may be a single group that is bonded to the nitrogen atom via a double bond, when R³ of Formula (2) is a hydrocarbyl group and R⁴ of Formula (2) is a group represented by Formula (4), the hydrocarbyl group denoted by R³ and R⁷ of R⁴ may be bonded to each other, when R³ and R⁴ of Formula (2) are groups represented by Formula (4) R⁷ of R³ and R⁷ of R⁴ may be bonded to each other, and * denotes a bonding position.)

*—O—R⁹—* (5)

(In the formula, R⁹ denotes a hydrocarbylene group having 1 to 10 carbon atoms, * denotes a bonding position, and R⁹ is bonded to the nitrogen atom of Formula (4).)

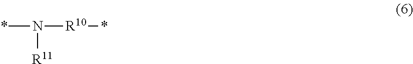

(In the formula, R¹⁰ denotes a hydrocarbylene group having 1 to 10 carbon atoms, R¹¹ denotes a hydrogen atom or a hydrocarbyl group having 1 to 10 carbon atoms, * denotes a bonding position, and R¹⁰ is bonded to the nitrogen atom of Formula (4).)

In Formula (4), m is 0 or 1.

In Formula (4), T denotes a hydrocarbylene group having 1 to 10 carbon atoms, a group represented by Formula (5), or a group represented by Formula (6).

Examples of the hydrocarbylene group having 1 to 10 carbon atoms denoted by T include an alkylene group such as a methylene group, an ethylene group, a trimethylene group, a tetramethylene group, a pentamethylene group, or a hexamethylene group; and an arylene group such as a phenylene group or a naphthylene group.

In Formula (5), R⁹ denotes a hydrocarbylene group having 1 to 10 carbon atoms, and in Formula (6), R¹⁰ denotes a hydrocarbylene group having 1 to 10 carbon atoms and R¹¹ denotes a hydrogen atom or a hydrocarbyl group having 1 to 10 carbon atoms.

Examples of the hydrocarbylene group having 1 to 10 carbon atoms denoted by R⁹ and R¹⁰ include an alkylene group such as a methylene group, an ethylene group, a trimethylene group, a tetramethylene group, a pentamethylene group, or a hexamethylene group; and an arylene group such as a phenylene group or a naphthylene group. It is preferably an ethylene group or a trimethylene group.

As the hydrocarbyl group having 1 to 10 carbon atoms denoted by R¹¹, an alkyl group, an aralkyl group, an aryl group, etc. can be cited. Examples of the alkyl group include a methyl group, an ethyl group, an n-propyl group, an isopropyl group, an n-butyl group, a sec-butyl group, and a tert-butyl group. Examples of the aralkyl group include a benzyl group. Examples of the aryl group include a phenyl group. It is preferably an alkyl group having 1 to 10 carbon atoms, and more preferably a methyl group or an ethyl group. R¹¹ is preferably a hydrogen atom or an alkyl group having 1 to 10 carbon atoms, and more preferably a hydrogen atom, a methyl group, or an ethyl group.

Examples of the group represented by Formula (5) include a group represented by —O—CH₂CH₂— and a group represented by —O—CH₂CH₂CH₂—.

Examples of the group represented by Formula (6) include a group represented by —NH—CH₂CH₂— and a group represented by —NH—CH₂CH₂CH₂—.

In Formula (4), R⁷ and R⁸ independently denote a hydrogen atom, a hydrocarbyl group having 1 to 10 carbon atoms, or a trialkylsilyl group, R⁷ and R⁸ may be bonded to each other, R⁷ and R⁸ may be a single group that is bonded to the nitrogen atom via a double bond, and R⁷ of R⁴ and R³ of Formula (2) may be bonded to each other.

As the hydrocarbyl group having 1 to 10 carbon atoms denoted by R⁷ and R⁸, an alkyl group, an aryl group, etc. can be cited. Examples of the alkyl group include a methyl group, an ethyl group, an n-propyl group, an isopropyl group, an n-butyl group, a sec-butyl group, and a tert-butyl group. Examples of the aryl group include a phenyl group. It is preferably an alkyl group, and more preferably an alkyl group having 1 to 4 carbon atoms.

Examples of the trihydrocarbylsilyl group denoted by R⁷ and R⁸ include a trialkylsilyl group such as a trimethylsilyl group, a triethylsilyl group, a triisopropylsilyl group, or a tert-butyldimethylsilyl group. It is preferably a trialkylsilyl group having 3 to 9 carbon atoms, and more preferably a trialkylsilyl group in which the alkyl group bonded to the silicon atom is an alkyl group having 1 to 3 carbon atoms.

Examples of a divalent group (—R⁷-R⁸—) in which R⁷ and R⁸ are bonded include an alkylene group such as an ethylene group, a trimethylene group, a tetramethylene group, a pentamethylene group, or a hexamethylene group; a nitrogen atom-containing hydrocarbylene group such as a group represented by —CH₂CH₂—NH—CH₂—, a group represented by —CH₂CH₂—N═CH—, a group represented by —CH═CH—N═CH—, or a group represented by —CH₂CH₂—NH—CH₂CH₂—; and an oxygen atom-containing hydrocarbylene group such as a group represented by —CH₂CH₂—O—CH₂CH₂—.

Examples of the single group denoted by R⁷ and R⁸ that is bonded to the nitrogen atom via a double bond include an ethylidene group, a propylidene group, a butylidene group, a 1-methylethylidene group, a 1-methylpropylidene group, and a 1,3-dimethylbutylidene group.

Examples of a divalent group (—R³-R⁷—) in which R⁷ of R⁴ and R³ of Formula (2) are bonded to each other include an alkylene group such as an ethylene group, a trimethylene group, a tetramethylene group, a pentamethylene group, or a hexamethylene group.

Examples of the group represented by Formula (4) in which m=0 include a dihydrocarbylamino group such as a dimethylamino group or a diethylamino group; a cyclic amino group such as a 1-aziridinyl group, a 1-pyrrolidinyl group, a 1-piperidinyl group, a 1-hexamethyleneimino group, a 1-imidazolyl group, a 4,5-dihydro-1-imidazolyl group, a 1-imidazolidinyl group, a 1-piperazinyl group, or a morpholino group, and a bis(trialkylsilyl)amino group such as a bis(trimethylsilyl)amino group, a bis(triethylsilyl)amino group, a bis(t-butyldimethylsilyl)amino group, or a bis(triisopropylsilyl)amino group.

Examples of the group represented by Formula (4) in which m=1 and T is a hydrocarbylene group include a dihydrocarbylaminoalkyl group such as a dimethylaminoethyl group, a diethylaminoethyl group, a dimethylaminopropyl group, or a diethylaminopropyl group; and a dihydrocarbylaminoaryl group such as a dimethylaminophenyl group or a diethylaminophenyl group.

Examples of the group represented by Formula (4) in which m=1 and T is a group represented by Formula (5) include a group represented by —O—CH₂CH₂—N(CH₃)₂, a group represented by —O—CH₂CH₂—N(CH₂CH₃)₂, a group represented by —O—CH₂CH₂CH₂—N(CH₃)₂, and a group represented by —O—CH₂CH₂CH₂—N(CH₂CH₃)₂.

Examples of the group represented by Formula (4) in which m=1 and T is a group represented by Formula (6) include a group represented by —NH—CH₂CH₂—N(CH₃)₂, a group represented by —NH—CH₂CH₂—N(CH₂CH₃)₂, and a group represented by —NH—CH₂CH₂CH₂—N(CH₃)₂, and a group represented by —NH—CH₂CH₂CH₂—N(CH₂CH₃)₂.

Examples of the compound represented by Formula (2) in which X is an oxygen atom, R³ is a hydrocarbyl group, and R⁴ is a group represented by Formula (4) include the compounds below, in which R³ is a vinyl group and in Formula (4) m=1 and T is a group represented by Formula (6).
N-(2-Dimethylaminoethyl)acrylamide,
N-(3-dimethylaminopropyl)acrylamide,
N-(4-dimethylaminobutyl)acrylamide,
N-(2-diethylaminoethyl)acrylamide,
N-(3-diethylaminopropyl)acrylamide,
N-(4-diethylaminobutyl)acrylamide,
N-(3-bistrimethylsilylaminopropyl)acrylamide, and
N-(3-morpholinopropyl)acrylamide.

Examples further include the compounds below, in which R³ is a 1-methylethenyl group and in Formula (4) m=1 and T is a group represented by Formula (6).
N-(2-Dimethylaminoethyl)methacrylamide,
N-(3-dimethylaminopropyl)methacrylamide,
N-(4-dimethylaminobutyl)methacrylamide,
N-(2-diethylaminoethyl)methacrylamide,
N-(3-diethylaminopropyl)methacrylamide,
N-(4-diethylaminobutyl)methacrylamide,
N-(3-bistrimethylsilylaminopropyl)methacrylamide, and
N-(3-morpholinopropyl)methacrylamide.

Examples of the compound represented by Formula (2) in which X is an oxygen atom, R³ is a hydrocarbyl group, and R⁴ is a group represented by Formula (4) include the compounds below, in which R³ is a vinyl group and in Formula (4) m=0.
N,N-Dimethylacrylamide,
N,N-diethylacrylamide,
N,N-bistrimethylsilylacrylamide, and
morpholinoacrylamide.

Examples further include the compounds below, in which R³ is a 1-methylethenyl group and in Formula (4) m=0.
N,N-Dimethylmethacrylamide,
N,N-diethylmethacrylamide,
N,N-bistrimethylsilylmethacrylamide, and
morpholinomethacrylamide.

The compound represented by Formula (2) is preferably a compound in which X is an oxygen atom, R³ is a vinyl group or a 1-methylethenyl group, R⁴ is a group represented by Formula (4), and in Formula (4) m=1 and T is a group represented by Formula (6).

It is more preferably
N-(3-dimethylaminopropyl)acrylamide,
N-(3-diethylaminopropyl)acrylamide,
N-(3-dimethylaminopropyl)methacrylamide, or
N-(3-diethylaminopropyl)methacrylamide.

In order to increase strength, the conjugated diene polymer of the present invention preferably contains a vinyl aromatic hydrocarbon-based monomer unit (vinyl aromatic hydrocarbon unit). Examples of the vinyl aromatic hydrocarbon include styrene, α-methylstyrene, vinyltoluene, vinylnaphthalene, divinylbenzene, trivinylbenzene, and divinylnaphthalene.

It is preferably styrene.

The content of the vinyl aromatic hydrocarbon-based monomer unit, relative to 100 wt % of the total amount of the conjugated diene unit and the vinyl aromatic hydrocarbon-based monomer unit, is preferably not less than 10 wt % (the content of the conjugated diene unit being not more than 90 wt %), and more preferably not less than 15 wt % (the content of the conjugated diene unit being not more than 85 wt %). Furthermore, in order to improve fuel economy, the content of the vinyl aromatic hydrocarbon-based monomer unit is preferably not more than 50 wt % (the content of the conjugated diene unit being not less than 50 wt %), and more preferably not more than 45 wt % (the content of the conjugated diene unit being not less than 55 wt %).

In order to increase strength, the Mooney viscosity (ML₁₊₄) of the conjugated diene polymer of the present invention is preferably not less than 10, and more preferably not less than 20. Furthermore, in order to improve processability, it is preferably not more than 200, and more preferably not more than 150. The Mooney viscosity (ML₁₊₄) is measured at 100° C. in accordance with JIS K6300 (1994).

In order to improve fuel economy, the vinyl bond content of the conjugated diene polymer of the present invention is preferably not more than 80 mol %, and more preferably not more than 70 mol % per 100 mol % of the conjugated diene-based monomer unit. Furthermore, in order to improve grip properties, it is preferably not less than 10 mol %, more preferably not less than 15 mol %, yet more preferably not less than 20 mol %, and particularly preferably not less than 40 mol %. The vinyl bond content is typically measured by IR spectroscopy from the absorption intensity at around 910 cm-1, which is an absorption peak of a vinyl group.

The content of the monomer unit based on the compound represented by Formula (1) is, in order to improve fuel economy, preferably not less than 0.01 wt % relative to 100 wt % of the conjugated diene polymer, and more preferably not less than 0.02 wt %. Furthermore, in order to improve economic efficiency it is preferably not more than 2 wt %, and more preferably not more than 1 wt %.

In order to improve fuel economy, the molecular weight distribution of the conjugated diene polymer of the present invention is preferably 1 to 5, and more preferably 1 to 2. The molecular weight distribution is obtained by measuring number-average molecular weight (Mn) and weight-average molecular weight (Mw) by a gel permeation chromatograph (GPC) method, and dividing Mw by Mn.

As a preferred method for producing the conjugated diene polymer of the present invention, a production method including steps A and B below can be cited.

(Step A): a step of polymerizing monomer components including a conjugated diene and a compound represented by Formula (1) above in a hydrocarbon solvent using an alkali metal catalyst, thus giving a polymer containing a monomer unit based on a compound represented by Formula (1) above between a conjugated diene-based monomer unit-containing partial chain (not containing a monomer unit based on a compound represented by Formula (1)) and a conjugated diene-based monomer unit-containing partial chain (not containing a monomer unit based on a compound represented by Formula (1)), the polymer having an alkali metal catalyst-derived alkali metal in at least one terminus of a polymer chain.
(Step B): a step of reacting the polymer obtained in step A and a compound represented by Formula (2) above.

Examples of the alkali metal catalyst that may be used in (step A) include an alkali metal, an organoalkali metal compound, a complex between an alkali metal and a polar compound, an oligomer having an alkali metal, etc. Examples of the alkali metal include lithium, sodium, potassium, rubidium, and cesium. Examples of the organoalkali metal compound include ethyllithium, n-propyllithium, iso-propyllithium, n-butyllithium, sec-butyllithium, t-octyllithium, n-decyllithium, phenyllithium, 2-naphthyllithium, 2-butylphenyllithium, 4-phenylbutyllithium, cyclohexyllithium, 4-cyclopentyllithium, dimethylaminopropyllithium, diethylaminopropyllithium, t-butyldimethylsilyloxypropyllithium, N-morpholinopropyllithium, lithium hexamethyleneimide, lithium pyrrolidide, lithium piperidide, lithium heptamethyleneimide, lithium dodecamethyleneimide, 1,4-dilithio-2-butene, sodium naphthalenide, sodium biphenylide, and potassium naphthalenide. Examples of the complex between an alkali metal and a polar compound include a potassium-tetrahydrofuran complex and a potassium-diethoxyethane complex, and examples of the oligomer having an alkali metal include the sodium salt of α-methylstyrene tetramer. It is preferably an organolithium compound or an organosodium compound, and more preferably an organolithium compound having 2 to 20 carbon atoms or an organosodium compound having 2 to 20 carbon atoms.

The hydrocarbon solvent used in step A is a solvent that does not deactivate the organoalkali metal compound catalyst, and examples thereof include an aliphatic hydrocarbon, an aromatic hydrocarbon, and an alicyclic hydrocarbon. Examples of the aliphatic hydrocarbon include propane, n-butane, iso-butane, n-pentane, iso-pentane, n-hexane, propene, 1-butene, iso-butene, trans-2-butene, cis-2-butene, 1-pentene, 2-pentene, 1-hexene, and 2-hexene. Examples of the aromatic hydrocarbon include benzene, toluene, xylene, and ethylbenzene, and examples of the alicyclic hydrocarbon include cyclopentane and cyclohexane.

One or more types thereof are used. The hydrocarbon solvent may be a mixture of various types of components, as in industrial hexane. It is preferably a hydrocarbon having 2 to 12 carbon atoms, and more preferably an aliphatic saturated hydrocarbon having 5 to 8 carbon atoms.

In step A, monomer components including a conjugated diene and a compound represented by Formula (1) above are polymerized in a hydrocarbon solvent using an alkali metal catalyst, thus producing a polymer having an alkali metal derived from the catalyst in at least one terminus of a polymer chain having a conjugated diene-based monomer unit and a monomer unit based on a compound represented by Formula (1) above.

Examples of the conjugated diene include 1,3-butadiene, isoprene, 1,3-pentadiene, 2,3-dimethyl-1,3-butadiene, and 1,3-hexadiene. One or more types thereof may be used. Among them, 1,3-butadiene and isoprene are preferable.

The amount of compound represented by Formula (1) used relative to 100 wt % of the total amount of monomer components used in polymerization is, in order to improve fuel economy, preferably not less than 0.01 wt %, and more preferably not less than 0.02 wt %. Furthermore, in order to improve economic efficiency, it is preferably not more than 2 wt %, and more preferably not more than 1 wt %.

In step A, polymerization may be carried out by combining, as monomers, the conjugated diene and the compound represented by Formula (1) with a vinyl aromatic hydrocarbon, and examples of the vinyl aromatic hydrocarbon include styrene, α-methylstyrene, vinyltoluene, vinylnaphthalene, divinylbenzene, trivinylbenzene, and divinylnaphthalene. It is preferably styrene.

The amount of vinyl aromatic hydrocarbon used relative to 100 wt % of the total amount of conjugated diene and vinyl aromatic hydrocarbon used is not less than 0 wt % (the amount of conjugated diene used being not more than 100 wt %), and in order to improve strength it is preferably not less than 10 wt % (the amount of conjugated diene used being not more than 90 wt %), and more preferably not less than 15 wt % (the amount of conjugated diene used being not more than 85 wt %). Furthermore, in order to improve fuel economy, the amount of vinyl aromatic hydrocarbon used is preferably not more than 50 wt % (the amount of conjugated diene used being not less than 50 wt %), and more preferably not more than 45 wt % (the amount of conjugated diene used being not less than 55 wt %).

The polymerization in step A may be carried out in the presence of an agent for regulating the vinyl bond content of the conjugated diene unit, an agent for regulating the distribution in the conjugated diene polymer chain of the conjugated diene unit and a monomer unit based on a monomer other than the conjugated diene (hereafter, generally called ‘regulators’), etc. Examples of such agents include an ether compound, a tertiary amine, and a phosphine compound. Specific examples of the ether compound include cyclic ethers such as tetrahydrofuran, tetrahydropyran, and 1,4-dioxane; aliphatic monoethers such as diethyl ether and dibutyl ether; aliphatic diethers such as ethylene glycol dimethyl ether, ethylene glycol diethyl ether, ethylene glycol dibutyl ether, diethylene glycol diethyl ether, and diethylene glycol dibutyl ether; and aromatic ethers such as diphenyl ether and anisole. Specific examples of the tertiary amine include triethylamine, tripropylamine, tributylamine, N,N,N′,N′-tetramethylethylenediamine, N,N-diethylaniline, pyridine, and quinoline. Specific examples of the phosphine compound include trimethylphosphine, triethylphosphine, and triphenylphosphine. One or more types thereof may be used.

The polymerization temperature in step A is preferably 25° C. to 100° C., more preferably 35° C. to 90° C., and yet more preferably 50° C. to 80° C. The polymerization time is preferably 10 minutes to 5 hours.

Step A preferably includes steps a1, a2, and a3 below.

(Step a1): a step of polymerizing a monomer component including a conjugated diene in a hydrocarbon solvent using an alkali metal catalyst, thus giving a conjugated diene polymer having an alkali metal derived from the catalyst in a polymer chain terminus
(Step a2): a step of adding a compound represented by Formula (1) to a hydrocarbon solution of the conjugated diene polymer having an alkali metal derived from the alkali metal catalyst in a polymer chain terminus to thus react the vinyl compound with the polymer chain terminus, thus giving a conjugated diene polymer having in a polymer chain terminus a structure in which the alkali metal derived from the alkali metal catalyst is bonded to a monomer unit based on the compound represented by Formula (1)
(Step a3): a step of adding a monomer component including a conjugated diene to a hydrocarbon solution of the conjugated diene polymer having in a polymer chain terminus a structure in which the alkali metal derived from the alkali metal catalyst is bonded to a monomer unit based on the compound represented by Formula (1), thus polymerizing the monomer component at the polymer chain terminus

In step B, the amount of compound represented by Formula (2) that is reacted with the polymer prepared in step A per mole of alkali metal derived from an alkali metal catalyst is preferably from 0.1 to 3 mole, more preferably from 0.5 to 2 mole, and yet more preferably from 0.7 to 1.5 mole.

In step B, the temperature at which the polymer prepared in step A and the compound represented in formula (2) are reacted is preferably 25° C. to 100° C., more preferably 35° C. to 90° C., and yet more preferably 50° C. to 80° C. The reaction time is preferably 60 sec to 5 hours, and more preferably 5 min to 1 hour, and yet more preferably 15 min to 1 hour.

In the production method of the present invention, a coupling agent may be added to the hydrocarbon solution of the conjugated diene polymer as necessary from initiation of polymerization of monomer using an alkali metal catalyst to termination of polymerization. Examples of the coupling agent include a compound of formula (7) below.

R¹²ₐML₄₋ₐ (7)

(In the formula, R¹² denotes an alkyl group, an alkenyl group, a cycloalkenyl group, or an aromatic residue, M denotes a silicon atom or a tin atom, L denotes a halogen atom or a hydrocarbyloxy group, and a denotes an integer of 0 to 2.)

Here, the aromatic residue denotes a monovalent group in which a hydrogen bonded to an aromatic ring is removed from an aromatic hydrocarbon.

Examples of the coupling agent of formula (7) include silicon tetrachloride, methyltrichlorosilane, dimethyldichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

In order to improve processability of the conjugated diene polymer, the amount of coupling agent added is preferably not less than 0.03 mol per mol of the alkali metal originating from the alkali metal catalyst, and more preferably not less than 0.05 mol. Furthermore, in order to improve fuel economy, it is preferably not more than 0.4 mol, and more preferably not more than 0.3 mol.

The conjugated diene polymer may be recovered from the hydrocarbon solution of the conjugated diene polymer by a known recovery method such as, for example, (1) a method in which a coagulant is added to the hydrocarbon solution of the conjugated diene polymer or (2) a method in which steam is added to the hydrocarbon solution of the conjugated diene polymer. The conjugated diene polymer thus recovered may be dried by a known dryer such as a band dryer or an extrusion dryer.

The conjugated diene polymer of the present invention may be used in a conjugated diene polymer composition by combining another polymer component, an additive, etc. therewith.

Examples of said other polymer component include conventional styrene-butadiene copolymer rubber, polybutadiene rubber, butadiene-isoprene copolymer rubber, and butyl rubber. Examples further include natural rubber, an ethylene-propylene copolymer, and an ethylene-octene copolymer. One or more types of the polymer components may be used.

In the case where another polymer component is combined with the conjugated diene polymer of the present invention, in order to improve fuel economy, the amount of conjugated diene polymer of the present invention is preferably not less than 10 parts by weight, and more preferably not less than 20 parts by weight per 100 parts by weight of the total amount of polymer components combined (including the amount of conjugated diene polymer combined).

As the additive, a known additive may be used, and examples thereof include a vulcanizing agent such as sulfur; a vulcanization accelerator such as a thiazole-based vulcanization accelerator, a thiuram-based vulcanization accelerator, a sulfenamide-based vulcanization accelerator, or a guanidine-based vulcanization accelerator; a vulcanization activator such as stearic acid or zinc oxide; an organic peroxide; a reinforcing agent such as silica or carbon black; a filler such as calcium carbonate, talc, alumina, clay, aluminum hydroxide, or mica; a silane coupling agent; an extender oil; a processing aid; an antioxidant; and a lubricant.

Examples of the silica include dry silica (anhydrous silicic acid), wet silica (hydrated silicic acid), colloidal silica, precipitated silica, calcium silicate, and aluminum silicate. One or more type thereof may be used. The BET specific surface area of the silica is preferably 50 to 250 m²/g. The BET specific surface area is measured in accordance with ASTM D1993-03. As a commercial product, product name Ultrasil VN3-G manufactured by Degussa, Inc., product names VN3, AQ, ER, and RS-150 manufactured by Tosoh Silica Corporation, product names Zeosil 1115 MP and 1165 MP manufactured by Rhodia, etc. may be used.

Examples of the carbon black include furnace black, acetylene black, thermal black, channel black, and graphite. With regard to the carbon black, channel carbon black such as EPC, MPC, or CC; furnace carbon black such as SAF, ISAF, HAF, MAF, FEF, SRF, GPF, APF, FF, CF, SCF, or ECF; thermal carbon black such as FT or MT; and acetylene carbon black can be cited as examples. One or more type thereof may be used.

The nitrogen adsorption specific surface area (N₂SA) of the carbon black is preferably 5 to 200 m²/g, and the dibutyl phthalate (DBP) absorption of the carbon black is preferably 5 to 300 ml/100 g. The nitrogen adsorption specific surface area is measured in accordance with ASTM D4820-93, and the DBP absorption is measured in accordance with ASTM D2414-93. As a commercial product, product name DIABLACK N339 manufactured by Mitsubishi Chemical Corp., product names SEAST 6, SEAST 7HM, and SEAST KH manufactured by Tokai Carbon Co., Ltd., and product names CK 3 and Special Black 4A manufactured by Degussa, Inc., etc. may be used.

Examples of the silane coupling agent include vinyltrichlorosilane, vinyltriethoxysilane, vinyltris(β-methoxyethoxy)silane, β-(3,4-epoxycyclohexyl)ethyltrimethoxysilane, γ-glycidoxypropyltrimethoxysilane, methacryloxypropyltrimethoxysilane, N-(β-aminoethyl)-γ-aminopropyltrimethoxysilane, N-(β-aminoethyl)-γ-aminopropylmethyldimethoxysilane, N-phenyl-γ-aminopropyltrimethoxysilane, γ-chloropropyltrimethoxysilane, γ-mercaptopropyltrimethoxysilane, γ-aminopropyltriethoxysilane, bis(3-(triethoxysilyl)propyl) disulfide, bis(3-(triethoxysilyl)propyl) tetrasulfide, γ-trimethoxysilylpropyldimethylthiocarbamyl tetrasulfide, and γ-trimethoxysilylpropylbenzothiazyl tetrasulfide. One or more type thereof may be used. As a commercial product, product names Si69 and Si75 manufactured by Degussa, Inc., etc. may be used.

Examples of the extender oil include an aromatic mineral oil (viscosity-gravity constant (V.G.C. value) 0.900 to 1.049), a naphthenic mineral oil (V.G.C. value 0.850 to 0.899), and a paraffinic mineral oil (V.G.C. value 0.790 to 0.849). The polycyclic aromatic content of the extender oil is preferably less than 3 wt %, and more preferably less than 1 wt %. The polycyclic aromatic content is measured in accordance with British Institute of Petroleum method 346/92. Furthermore, the aromatic compound content (CA) of the extender oil is preferably not less than 20 wt %. One or more types of the extender oil may be used.

Examples of the vulcanization accelerator include thiazole-based vulcanization accelerators such as 2-mercaptobenzothiazole, dibenzothiazyl disulfide, and N-cyclohexyl-2-benzothiazylsulfenamide; thiuram-based vulcanization accelerators such as tetramethylthiuram monosulfide and tetramethylthiuram disulfide; sulfenamide-based vulcanization accelerators such as N-cyclohexyl-2-benzothiazolesulfenamide, N-t-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; and guanidine-based vulcanization accelerators such as diphenylguanidine, diorthotolylguanidine and orthotolylbiguanidine. The amount thereof used is preferably 0.1 to 5 parts by weight, and more preferably 0.2 to 3 parts by weight relative to 100 parts by weight of the total amount of polymer components combined (including the amount of conjugated diene polymer combined).

When a conjugated diene polymer composition is formed by adding a reinforcing agent with the conjugated diene polymer of the present invention, the amount of the reinforcing agent added, relative to 100 parts by weight of the conjugated diene polymer of the present invention added, is preferably 10 to 150 parts by weight. In order to improve abrasion resistance and strength, the amount added is more preferably not less than 20 parts by weight, and yet more preferably not less than 30 parts by weight. In order to enhance reinforcement, it is preferably not more than 120 parts by weight, and more preferably not more than 100 parts by weight.

When a conjugated diene polymer composition in which a reinforcing agent is added to the conjugated diene polymer of the present invention is used, in order to improve fuel economy, it is preferable to use silica as a reinforcing agent. The amount of silica added is preferably not less than 50 parts by weight relative to 100 parts by weight of the total amount of reinforcing agents added, and more preferably not less than 70 parts by weight.

When a conjugated diene polymer composition is formed by adding a silane coupling agent to the conjugated diene polymer of the present invention, the content of the silane coupling agent per 100 parts by weight of silica is preferably from 1 to 20 parts by weight, more preferably from 2 to 15 parts by weight, and yet more preferably from 5 to 10 parts by weight.

As a method for producing a conjugated diene polymer composition by adding to another polymer component, an additive, etc. with the conjugated diene polymer of the present invention, a known method such as, for example, a method in which the components are kneaded by means of a known mixer such as a roll or Banbury mixer can be used.

With regard to kneading conditions, when an additive other than a vulcanizing agent or a vulcanization accelerator is added, the kneading temperature is preferably 50° C. to 200° C. and more preferably 80° C. to 190° C., and the kneading time is preferably 30 sec to 30 min and more preferably 1 min to 30 min. When a vulcanizing agent or a vulcanization accelerator is added, the kneading temperature is preferably not more than 100° C., and more preferably room temperature to 80° C. A composition in which a vulcanizing agent or a vulcanization accelerator is added is usually used after carrying out a vulcanization treatment such as press vulcanization. The vulcanization temperature is preferably 120° C. to 200° C., and more preferably 140° C. to 180° C.

The conjugated diene polymer and the conjugated diene polymer composition of the present invention have excellent fuel economy. The abrasion resistance is also good.

The conjugated diene polymer and the conjugated diene polymer composition of the present invention are used for tires, shoe soles, flooring materials, vibration-proofing materials, etc., and are particularly suitably used for tires.

In accordance with the present invention, there can be provided a conjugated diene polymer that can give a conjugated diene polymer composition having excellent fuel economy, a polymer composition formed by combining the conjugated diene polymer and a reinforcing agent such as silica, and a method for producing the conjugated diene polymer.

### EXAMPLES

The present invention is explained below by reference to Examples.

Physical properties were evaluated by the following methods.

### 1. Mooney Viscosity (ML₁₊₄)

The Mooney viscosity of a polymer was measured at 100° C. in accordance with JIS K6300 (1994).

### 2. Vinyl Bond Content (Units: Mol %)

The vinyl bond content of a polymer was determined by IR spectroscopy from the absorption intensity at around 910 cm⁻¹, which is an absorption peak of a vinyl group.

### 3. Styrene Unit Content (Units: Wt %)

The styrene unit content of a polymer was determined from refractive index in accordance with JIS K6383 (1995).

### 4. Molecular Weight Distribution (Mw/Mn)

Weight-average molecular weight (Mw) and number-average molecular weight (Mn) were measured under conditions (1) to (8) below by a gel permeation chromatograph (GPC) method, and the molecular weight distribution (Mw/Mn) of a polymer was determined.

(1) Instrument: HLC-8220 manufactured by Tosoh Corporation
(2) Separation column: HM-H (2 columns in tandem) manufactured by Tosoh Corporation
(3) Measurement temperature: 40° C.
(4) Carrier: tetrahydrofuran
(5) Flow rate: 0.6 mL/min
(6) Amount injected: 5 μL
(7) Detector: differential refractometer
(8) Molecular weight standard: standard polystyrene

### 5. Fuel Economy

A strip-shaped test piece having a width of 1 or 2 mm and a length of 40 mm was stamped out from a sheet-shaped vulcanized molding and used for testing. The loss tangent (tan δ (70° C.)) at 70° C. of the test piece was measured using a viscoelastometer (Ueshima Seisakusho Co., Ltd.) under conditions of a strain of 1% and a frequency of 10 Hz. The smaller this value, the better the fuel economy.

### 6. Abrasion Resistance

A ring-shaped vulcanized molded body was used as a test piece; the amounts abraded under conditions of a load of 10 pounds and a test piece rotational speed of 300 rpm for 500 to 1,500 rotations, 1,500 to 2,500 rotations, and 2,500 to 3,500 rotations were measured using an Akron abrasion tester (Ueshima Seisakusho Co., Ltd.), and the average value thereof was calculated. The smaller this value, the better the abrasion resistance.

### Example 1

A 20 liter capacity stainless polymerization reactor equipped with a stirrer was washed, dried, and flushed with dry nitrogen. Subsequently, the polymerization reactor was charged with 10.2 kg of industrial hexane (density 680 kg/m³), 608 g of 1,3-butadiene, 192 g of styrene, 6.1 mL of tetrahydrofuran, and 4.12 mL of ethylene glycol diethyl ether. Subsequently, 14.86 mmol of n-butyllithium was charged into the polymerization reactor as an n-hexane solution, and a polymerization reaction was started.

Copolymerization of 1,3-butadiene and styrene was carried out at a stirring speed of 130 rpm and a polymerization reactor internal temperature of 65° C. for 45 minutes while continuously supplying the monomers to the polymerization reactor. The amount of 1,3-butadiene supplied was 304 g, and the amount of styrene supplied was 96 g.

When 45 minutes had passed after the addition of n-butyllithium, the polymerization reactor was charged with a cyclohexane solution of 12.80 mmol (2.86 g) of 1-(4-N,N-dimethylaminophenyl)-1-phenylethylene, and the polymer solution was stirred at a stirring speed of 130 rpm.

When 65 minutes had passed after the addition of 1-(4-N,N-dimethylaminophenyl)-1-phenylethylene, a copolymerization reaction of 1,3-butadiene and styrene was carried out for 130 minutes while supplying monomers to the polymerization reactor. During polymerization, the stirring speed was 130 rpm and the polymerization reactor internal temperature was 65° C. The amount of 1,3-butadiene supplied was 608 g, and the amount of styrene supplied was 192 g. Of the entire amount of monomers charged and supplied to the polymerization reactor, the amount of 1-(4-N,N-dimethylaminophenyl)-1-phenylethylene charged was 0.14 wt %.

Subsequently, the polymer solution thus obtained was stirred at a stirring speed of 130 rpm, 12.8 mmol of N-(3-dimethylaminopropyl)acrylamide was added to the polymer solution, and stirring was carried out for a further 15 minutes. Subsequently, 20 mL a hexane solution containing 0.8 mL of methanol was added to the polymer solution, and the polymer solution was stirred for a further 5 minutes.

To the polymer solution were added 8.0 g of 2-tert-butyl-6-(3-tert-butyl-2-hydroxy-5-methylbenzyl)-4-methylphenyl acrylate (product name: Sumilizer GM, manufactured by Sumitomo Chemical Co., Ltd.) and 4.0 g of pentaerythrityl tetrakis(3-laurylthiopropionate) (product name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer.

The results of evaluation of the polymer are given in Table 1.

100 parts by weight of the polymer thus obtained, 78.4 parts by weight of silica (product name: Ultrasil VN3-G, manufactured by Degussa, Inc.), 6.4 parts by weight of a silane coupling agent (product name: Si69, manufactured by Degussa, Inc.), 6.4 parts by weight of carbon black (product name: DIABLACK N339, manufactured by Mitsubishi Chemical Corp.), 47.6 parts by weight of an extender oil (product name: JOMO PROCESS NC-140, manufactured by Japan Energy Corp.), 1.5 parts by weight of an antioxidant (product name: Antigene 3C, manufactured by Sumitomo Chemical Co., Ltd.), 2 parts by weight of stearic acid, 2 parts by weight of zinc oxide, 1 part by weight of a vulcanization accelerator (product name: Soxinol CZ, manufactured by Sumitomo Chemical Co., Ltd.), 1 part by weight of a vulcanization accelerator (product name: Soxinol D, manufactured by Sumitomo Chemical Co., Ltd.), 1.5 parts by weight of a wax (product name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 1

A 5 liter capacity stainless polymerization reactor equipped with a stirrer was washed, dried, and flushed with dry nitrogen. Subsequently, the polymerization reactor was charged with 2.55 kg of industrial hexane (density 680 kg/m³), 137 g of 1,3-butadiene, 43 g of styrene, 1.51 mL of tetrahydrofuran, and 1.09 mL of ethylene glycol diethyl ether. Subsequently, 3.54 mmol of n-butyllithium was charged into the polymerization reactor as an n-hexane solution, and a polymerization reaction was started.

Copolymerization of 1,3-butadiene and styrene was carried out at a stirring speed of 130 rpm and a polymerization reactor internal temperature of 65° C. for 2 hours while continuously supplying the monomers to the polymerization reactor. The amount of 1,3-butadiene supplied was 205 g, and the amount of styrene supplied was 65 g.

Subsequently, the polymer solution thus obtained was stirred at a stirring speed of 130 rpm, a cyclohexane solution of 2.88 mmol (0.64 g) of 1-(4-N,N-dimethylaminophenyl)-1-phenylethylene was charged into the polymer solution, and stirring was carried out for a further 90 minutes. 10 mL of a hexane solution containing 0.2 mL of methanol was added to the polymer solution, and the polymer solution was stirred for a further 5 minutes.

Of the entire amount of monomers charged and supplied to the polymerization reactor, the amount of 1-(4-N,N-dimethylaminophenyl)-1-phenylethylene charged was 0.14 wt %.

To the polymer solution were added 1.8 g of 2-tert-butyl-6-(3-tert-butyl-2-hydroxy-5-methylbenzyl)-4-methylphenyl acrylate (product name: Sumilizer GM, manufactured by Sumitomo Chemical Co., Ltd.) and 0.9 g of pentaerythrityl tetrakis(3-laurylthiopropionate) (product name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (product name: Ultrasil VN3-G, manufactured by Degussa, Inc.), 6.4 parts by weight of a silane coupling agent (product name: Si69, manufactured by Degussa, Inc.), 6.4 parts by weight of carbon black (product name: DIABLACK N339, manufactured by Mitsubishi Chemical Corp.), 47.6 parts by weight of an extender oil (product name: JOMO PROCESS NC-140, manufactured by Japan Energy Corp.), 1.5 parts by weight of an antioxidant (product name: Antigene 3C, manufactured by Sumitomo Chemical Co., Ltd.), 2 parts by weight of stearic acid, 2 parts by weight of zinc oxide, 1 part by weight of a vulcanization accelerator (product name: Soxinol CZ, manufactured by Sumitomo Chemical Co., Ltd.), 1 part by weight of a vulcanization accelerator (product name: Soxinol D, manufactured by Sumitomo Chemical Co., Ltd.), 1.5 parts by weight of a wax (product name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

### Comparative Example 2

A 20 liter capacity stainless polymerization reactor equipped with a stirrer was washed, dried, and flushed with dry nitrogen. Subsequently, the polymerization reactor was charged with 10.2 kg of industrial hexane (density 680 kg/m³), 547 g of 1,3-butadiene, 173 g of styrene, 6.1 mL of tetrahydrofuran, and 4.7 mL of ethylene glycol diethyl ether. Subsequently, 13.31 mmol of n-butyllithium was charged into the polymerization reactor as an n-hexane solution, and a polymerization reaction was started.

Copolymerization of 1,3-butadiene and styrene was carried out at a stirring speed of 130 rpm and a polymerization reactor internal temperature of 65° C. for 3 hours while continuously supplying the monomers to the polymerization reactor. The amount of 1,3-butadiene supplied was 821 g, and the amount of styrene supplied was 259 g.

Following this, the polymer solution thus obtained was stirred at a stirring speed of 130 rpm, 11.25 mmol of N-(3-dimethylaminopropyl)acrylamide was added thereto, and stirring was carried out for 15 minutes. 20 mL of a hexane solution containing 0.8 mL of methanol was added to the polymer solution, and the polymer solution was stirred for a further 5 minutes.

To the polymer solution were added 8.0 g of 2-tert-butyl-6-(3-tert-butyl-2-hydroxy-5-methylbenzyl)-4-methylphenyl acrylate (product name: Sumilizer GM, manufactured by Sumitomo Chemical Co., Ltd.) and 4.0 g of pentaerythrityl tetrakis(3-laurylthiopropionate) (product name: Sumilizer TP-D, manufactured by Sumitomo Chemical Co., Ltd.). Subsequently, the polymer solution was evaporated at normal temperature for 24 hours, and further dried under vacuum at 55° C. for 12 hours, thus giving a polymer. The results of evaluation of the polymer are given in Table 1.

100 parts by weight of the polymer thus obtained, 78.4 parts by weight of silica (product name: Ultrasil VN3-G, manufactured by Degussa, Inc.), 6.4 parts by weight of a silane coupling agent (product name: Si69, manufactured by Degussa, Inc.), 6.4 parts by weight of carbon black (product name: DIABLACK N339, manufactured by Mitsubishi Chemical Corp.), 47.6 parts by weight of an extender oil (product name: JOMO PROCESS NC-140, manufactured by Japan Energy Corp.), 1.5 parts by weight of an antioxidant (product name: Antigene 3C, manufactured by Sumitomo Chemical Co., Ltd.), 2 parts by weight of stearic acid, 2 parts by weight of zinc oxide, 1 part by weight of a vulcanization accelerator (product name: Soxinol CZ, manufactured by Sumitomo Chemical Co., Ltd.), 1 part by weight of a vulcanization accelerator (product name: Soxinol D, manufactured by Sumitomo Chemical Co., Ltd.), 1.5 parts by weight of a wax (product name: Sunnoc N, manufactured by Ouchi Shinko Chemical Industrial Co., Ltd.), and 1.4 parts by weight of sulfur were kneaded by means of a Labo Plastomill to prepare a polymer composition. The polymer composition thus obtained was molded into a sheet using a 6 inch roll, and the sheet was vulcanized by heating at 160° C. for 45 minutes, thus giving a vulcanized sheet. The results of evaluation of the physical properties of the vulcanized sheet are given in Table 1.

TABLE 1

| | | | Comparative | Comparative |
|---|---|---|---|---|
| | | Example 1 | Example 1 | Example 2 |
| Mooney viscosity | — | 42.1 | 33.4 | 40.6 |
| Vinyl bond content | % by mole | 57.2 | 58.0 | 56.5 |
| Styrene unit content | wt % | 24.5 | 23.7 | 24.4 |
| Molecular weight | — | 1.11 | 1.06 | 1.09 |
| distribution | | | | |
| Fuel economy | — | 0.192 | 0.214 | 0.210 |
| tan δ (70° C.) | | | | |
| Abrasion resistance | Mg | 300 | 390 | 340 |
| Loss | | | | |

1. A conjugated diene polymer comprising:
a conjugated diene-based monomer unit and a monomer unit based on a compound represented by Formula (1) below,
the monomer unit based on a compound represented by Formula (1) below being between a conjugated diene-based monomer unit-containing partial chain and a conjugated diene-based monomer unit-containing partial chain (said partial chain not comprising a monomer unit based on a compound represented by Formula (1) below), and
the polymer having at least one terminus modified by a compound represented by Formula (2) below, 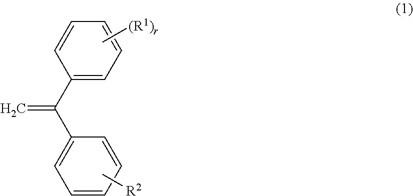
wherein r is 0 or 1, R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom, 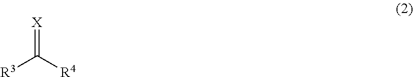
wherein X denotes an oxygen atom or a sulfur atom, R³ denotes a nitrogen atom- and/or oxygen atom-containing group, a hydrocarbyl group, or a hydrogen atom, R⁴ denotes a nitrogen atom- and/or oxygen atom-containing group, and R³ and R⁴ may be bonded to each other.

2. The polymer according to claim 1, wherein R¹ and R² of Formula (1) independently denote a group represented by Formula (3) below, a hydrocarbyl group, or a hydrogen atom, and at least one of R¹ and R² is a group represented by Formula (3) below, 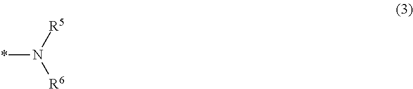
wherein R⁵ and R⁶ independently denote a hydrocarbyl group or a trihydrocarbylsilyl group, or R⁵ and R⁶ are bonded to each other and denote a hydrocarbylene group that may contain a nitrogen atom and/or an oxygen atom as a heteroatom, and * denotes a bonding position.

3. The polymer according to claim 1, wherein in Formula (2) X is an oxygen atom, R³ is a hydrocarbyl group or a group represented by Formula (4) below, R⁴ is a group represented by Formula (4) below, and R³ and R⁴ may be bonded to each other. 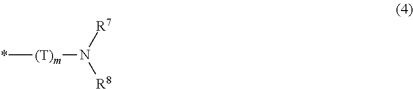
wherein m is 0 or 1, T denotes a hydrocarbylene group having 1 to 10 carbon atoms, a group represented by Formula (5) below, or a group represented by Formula (6) below, R⁷ and R⁸ independently denote a hydrogen atom, a hydrocarbyl group having 1 to 10 carbon atoms, or a trihydrocarbylsilyl group, or R⁷ and R⁸ are bonded to each other and denote a hydrocarbylene group that may contain a nitrogen atom and/or an oxygen atom as a heteroatom, R⁷ and R⁸ may be a single group that is bonded to the nitrogen atom via a double bond, when R³ of Formula (2) is a hydrocarbyl group and R⁴ of Formula (2) is a group represented by Formula (4) the hydrocarbyl group of R³ and R⁷ of R⁴ may be bonded to each other, when R³ and R⁴ of Formula (2) are groups represented by Formula (4) R⁷ of R³ and R⁷ of R⁴ may be bonded to each other, and * denotes a bonding position,
*—O—R⁹—* (5)
wherein R⁹ denotes a hydrocarbylene group having 1 to 10 carbon atoms, * denotes a bonding position, and R⁹ is bonded to the nitrogen atom of Formula (4), 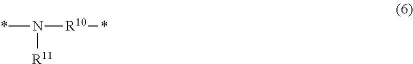
wherein R¹⁰ denotes a hydrocarbylene group having 1 to 10 carbon atoms, R¹¹ denotes a hydrogen atom or a hydrocarbyl group having 1 to 10 carbon atoms, * denotes a bonding position, and R¹⁰ is bonded to the nitrogen atom of Formula (4).

4. The polymer according to claim 1, wherein the vinyl bond content of the conjugated diene polymer, with the content of the conjugated diene-based monomer unit as 100% by mol, is not less than 20% by mol and not more than 70% by mol.

5. A conjugated diene polymer composition comprising the conjugated diene polymer according to claim 1 and a reinforcing agent.

6. The composition according to claim 5, wherein the reinforcing agent has a content of from 10 to 150 parts by weight per 100 parts by weight of the conjugated diene polymer.

7. A method for producing a conjugated diene polymer, comprising the steps of:
(A) polymerizing monomer components comprising a conjugated diene and a compound represented by Formula (1) below in a hydrocarbon solvent using an alkali metal catalyst, thus giving a polymer containing a monomer unit based on a compound represented by Formula (1) below between a conjugated diene-based monomer unit-containing partial chain and a conjugated diene-based monomer unit-containing partial chain (said partial chain not comprising a monomer unit based on a compound represented by Formula (1) below), the polymer having an alkali metal catalyst-derived alkali metal in at least one terminus of a polymer chain; and
(B) reacting the polymer obtained in step A and a compound represented by Formula (2) below, 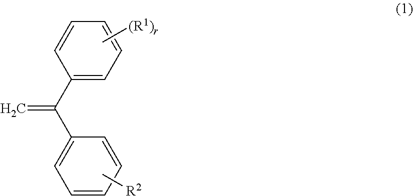
wherein r is 0 or 1, R¹ denotes a hydrocarbyl group or a group containing at least one atom selected from the atomic group consisting of a nitrogen atom, an oxygen atom, and a sulfur atom, and R² denotes a group containing at least one atom selected from the atomic group consisting of a nitrogen atom, an oxygen atom, and a sulfur atom, 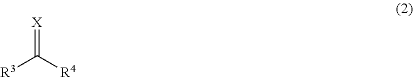
wherein X denotes an oxygen atom or a sulfur atom, R³ denotes a nitrogen atom- and/or oxygen atom-containing group, a hydrocarbyl group, or a hydrogen atom, R⁴ denotes a nitrogen atom- and/or oxygen atom-containing group, and R³ and R⁴ may be bonded to each other.

8. The method according to claim 7, wherein R¹ and R² of Formula (1) independently denote a group represented by Formula (3) below, a hydrocarbyl group, or a hydrogen atom, and at least one of R¹ and R² is a group represented by Formula (3) below, 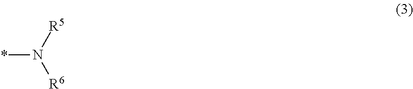
wherein R⁵ and R⁶ independently denote a hydrocarbyl group or a trihydrocarbylsilyl group, or R⁵ and R⁶ are bonded to each other and denote a hydrocarbylene group that may contain a nitrogen atom and/or an oxygen atom as a heteroatom, and * denotes a bonding position.

9. The method according to claim 7, wherein in Formula (2) X is an oxygen atom, R³ is a hydrocarbyl group or a group represented by Formula (4) below, R⁴ is a group represented by Formula (4) below, and R³ and R⁴ may be bonded to each other, 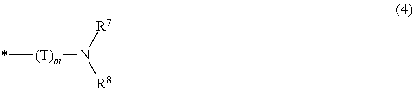
wherein m is 0 or 1, T denotes a hydrocarbylene group having 1 to 10 carbon atoms, a group represented by Formula (5) below, or a group represented by Formula (6) below, R⁷ and R⁸ are independently a hydrogen atom, a hydrocarbyl group having 1 to 10 carbon atoms, or a trihydrocarbylsilyl group, or R⁷ and R⁸ are bonded to each other and denote a hydrocarbylene group that may contain a nitrogen atom and/or an oxygen atom as a heteroatom, R⁷ and R⁸ may be a single group that is bonded to the nitrogen atom via a double bond, when R³ of Formula (2) is a hydrocarbyl group and R⁴ of Formula (2) is a group represented by Formula (4) a hydrocarbyl group of R³ and R⁷ of R⁴ may be bonded to each other, when R³ and R⁴ of Formula (2) are groups represented by Formula (4) R⁷ of R³ and R⁷ of R⁴ may be bonded to each other, and * denotes a bonding position,
*—O—R⁹—* (5)
wherein R⁹ denotes a hydrocarbylene group having 1 to 10 carbon atoms, * denotes a bonding position, and R⁹ is bonded to the nitrogen atom of Formula (4), 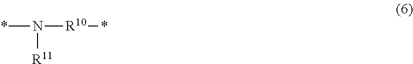
wherein R¹⁰ denotes a hydrocarbylene group having 1 to 10 carbon atoms, R¹¹ denotes a hydrogen atom or a hydrocarbyl group having 1 to 10 carbon atoms, * denotes a bonding position, and R¹⁰ is bonded to the nitrogen atom of Formula (4).
